(19) United States
(12) Patent Application Publication
(10) Pub. No.: US 2018/0118875 A1
(43) Pub. Date: May 3, 2018

(54) USE OF DYNAMIC CROSS-LINKED POLYMER COMPOSITIONS IN SOLDERING APPLICATIONS

(71) Applicant: SABIC Global Technologies B.V., Bergen op Zoom (NL)

(72) Inventors: Chiel Albertus LEENDERS, Fijnaart (NL); Franciscus Petrus Maria MERCX, Halsteren (NL); Ramon GROOTE, Oisterwijk (NL)

(21) Appl. No.: 15/560,608

(22) PCT Filed: Mar. 25, 2016
(86) PCT No.: PCT/IB2016/051729

§ 371 Date: Sep. 22, 2017

Related U.S. Application Data
(60) Provisional application No. 62/138,465, filed on Mar. 26, 2015.

(51) Int. Cl. C08G 59/24; B29C 65/48; C08G 59/42; C08G 59/70; C08G 63/91

(52) U.S. Cl. CPC C08G 59/245; B29C 65/4815; C08G 63/916; C08G 59/70; C08G 59/4276

(57) ABSTRACT

The disclosure is directed to the use of dynamic cross-linked polymer compositions in soldering applications. Workpieces comprising a solder bonded to at least one component comprising a dynamic cross-linked polymer composition are also described.

### CROSS REFERENCE TO RELATED APPLICATION

This application claims the benefit of U.S. Provisional Application No. 62/138,465, filed Mar. 26, 2015, the entirety of which is incorporated by reference herein.

### BACKGROUND

Described herein is the use of dynamic cross-linked polymer compositions in soldering applications.

Soldering requires temperatures high enough to melt the soldering material. These temperatures can exceed 180° C. Polymeric resins used in soldering applications must be able to withstand these temperatures.

Due to environmental concerns and governmental restrictions, manufacturers are reducing or eliminating the amount of lead-based solder used in electronics and other applications. Lead-free solder alloys typically have a melt temperature that is up to about 20° C. higher than conventional lead-based solders, resulting in higher soldering temperatures. Polymeric resins used in lead-free soldering applications must be able to withstand these higher soldering temperatures, while maintaining dimensional, structural, and mechanical stability.

Accordingly, there remains a need in the art for materials that can be used in soldering applications.

### SUMMARY

The above-described and other deficiencies of the art are met by workpieces comprising a solder bonded to at least one component comprising a dynamic cross-linked polymer composition. The above-described and other deficiencies of the art are also met by methods comprising applying a solder to a first component comprising a dynamic cross-linked polymer composition and heating the solder to a temperature that is at or above the melting point of the solder; wherein the dynamic cross-linked polymer composition exhibits a storage modulus of at least 0.01 MegaPascals (MPa) after the heating. Articles prepared using the methods described herein are also described.

The above described and other features are exemplified by the following detailed description, examples, and claims.

### BRIEF DESCRIPTION OF THE DRAWINGS

FIG. 1 depicts the oscillatory time sweep measurement curves representing the storage and loss modulus for a cross-linked polymer network.

FIG. 2 depicts the stress relaxation measurement curves representing the normalized modulus for a dynamic cross-linked polymer network.

FIG. 3 depicts a reflow soldering profile.

FIG. 4 depicts storage modulus of certain embodiments of the disclosure.

### DETAILED DESCRIPTION OF ILLUSTRATIVE EMBODIMENTS

Described herein are workpieces comprising a solder bonded to at least one component comprising a dynamic cross-linked polymer composition. Also described are methods comprising applying a solder to a first component comprising a dynamic cross-linked polymer composition; and heating the solder to a temperature that is at or above the melting point of the solder; wherein the dynamic cross-linked polymer composition exhibits a storage modulus of at least 0.01 MPa after the heating when tested in accordance with ISO 527.

The present disclosure may be understood more readily by reference to the following detailed description of desired embodiments and the examples included therein. In the following specification and the claims that follow, reference will be made to a number of terms which have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams (g) to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, “Tm” refers to the melting point at which a polymer loses its orderly arrangement.

As used herein, “Tc” refers to the crystallization temperature at which a polymer gives off heat originating from crystalline arrangement.

The terms “Glass Transition Temperature” or “Tg” may be measured using a differential scanning calorimetry method and expressed in degrees Celsius.

As used herein, “crosslink,” and its variants, refer to the formation of a stable covalent bond between two polymers. This term is intended to encompass the formation of covalent bonds that result in network formation, or the formation of covalent bonds that result in chain extension. The term “cross-linkable” refers to the ability of a polymer to form such stable covalent bonds.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently crosslinked networks that are able to change their topology through thermoactivated bond exchange reactions. The network is capable of reorganizing itself without altering the number of cross-links between its chains. At high temperatures, dynamic cross-linked polymer compositions achieve transesterification rates that permit chain-mobility due to exchange of crosslinks, so that the network behaves like a flexible rubber. At low temperatures, exchange reactions are very long and dynamic cross-linked polymer compositions behave like classical thermosets. The transition from the liquid to the solid is reversible and exhibits a glass transition and/or a melting point. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the crosslinks, a dynamic cross-linked polymer composition will not lose integrity above the glass transition temperature (Tg) or the melting point (Tm) like a thermoplastic resin will. The crosslinks are capable of rearranging themselves via bond exchange reactions between multiple crosslinks and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the invention can have Tg of about 40 to about 60° C. An article made from a dynamic cross-linked polymer composition can be heated and deformed, and upon returning to the original temperature, maintains the deformed shape. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610.

Examining the nature of a given polymer composition can distinguish whether the composition is cross-linked, reversibly cross-linked, or non-crosslinked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

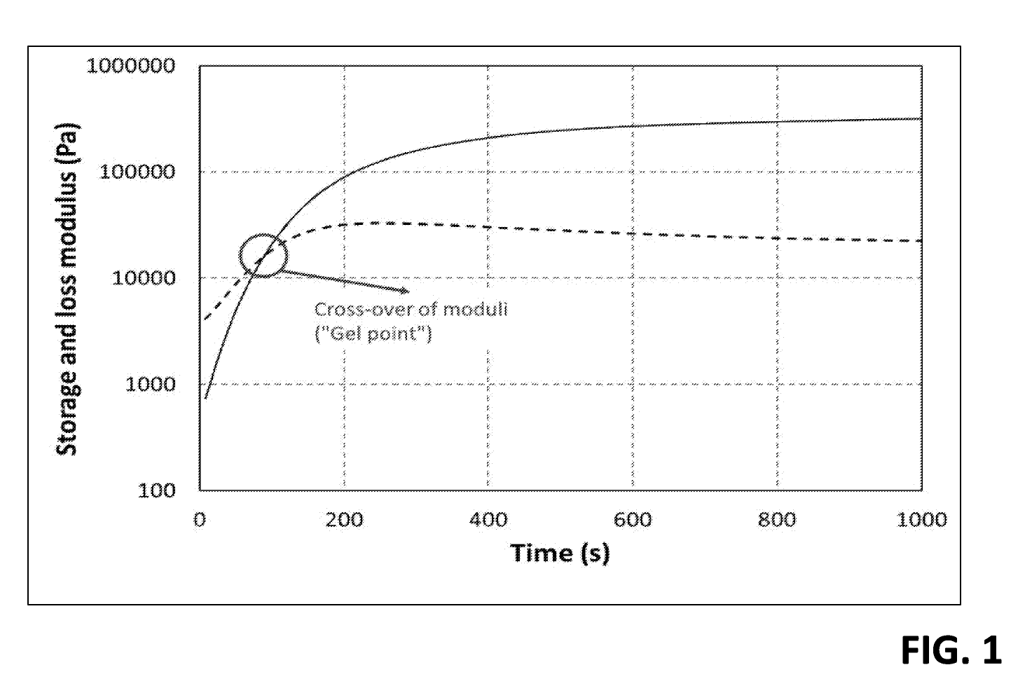

The cross-linked network apparent in dynamic and other conventional cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network. Storage (solid line) and loss (dashed line) modulus for a cross-linked polymer network are presented.

The orientation of the curves indicates whether or not the polymer has a cross-linked network. Initially, the loss modulus (viscous component) has a greater value than the storage modulus (elastic component) indicating that the material behaves like a viscous liquid. Over time, polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress relaxation rheology measurement may also, or alternatively, be performed at constant strain and temperature.

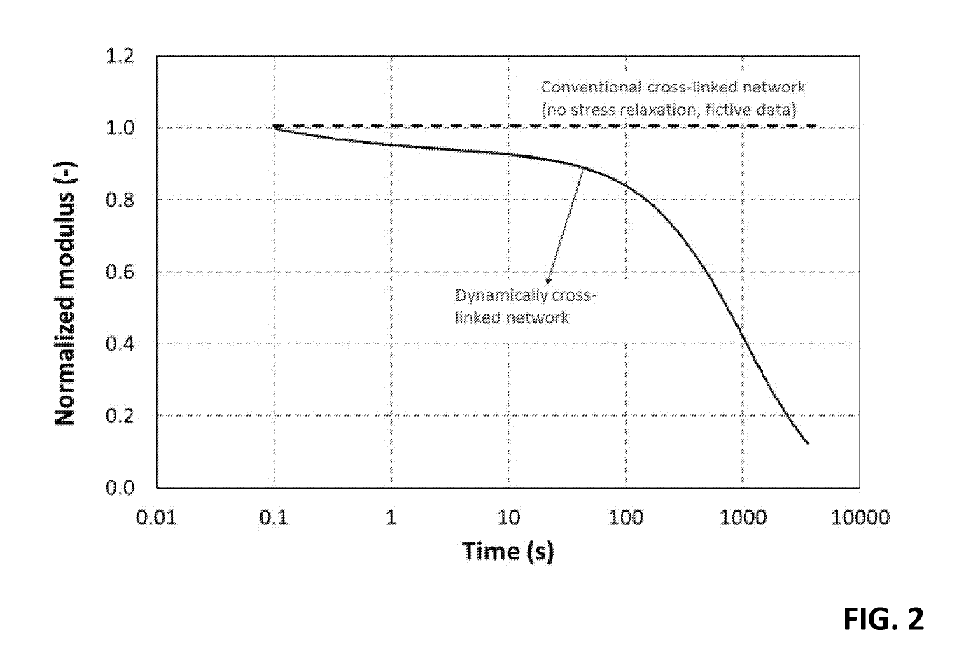

After network formation, the polymer may be heated and certain strain imposed on the polymer. The resulting evolution of the elastic modulus as a function of time reveals whether the polymer is dynamically or conventionally cross-linked. Exemplary curves for dynamically and conventionally cross-linked polymer networks are presented in FIG. 2. FIG. 2 presents the characteristic stress relaxation behavior with respect to normalized modulus over time (in seconds) of a dynamically cross-linked polymer network, compared to the absence of the stress-relaxation phenomenon for a conventional cross-linked polymer network (dashed line, fictive data).

Stress relaxation generally follows a multimodal behavior:

$$G / {G}_{0} = {\sum }_{i = 1}^{n} {C}_{i} exp ( - t / {τ}_{i} )$$

where the number (n), relative contribution (Ci) and characteristic timescales (τ i) of the different relaxation modes are governed by bond exchange chemistry, network topology and network density. For a conventional cross-linked networks, relaxation times approach infinity, τ→∞, and G/G0=1 (horizontal dashed line). Apparent in the curves for the normalized modulus (G/G0) as a function of time, a conventionally cross-linked network does not exhibit any stress relation because the permanent character of the cross-links prevents the polymer chain segments from moving with respect to one another. A dynamically cross-linked network, however, features bond exchange reactions allowing for individual movement of polymer chain segments thereby allowing for complete stress relation over time.

According to the disclosure, dynamically cross-linked polymer compositions have a characteristic timescale for relaxation of internal stresses of between 0.01 to 1,000,000 seconds, as measured by stress relaxation rheology experiments defined herein.

Provided in the disclosure are workpieces comprising a solder bonded to at least one component comprising a dynamic cross-linked polymer composition. As used herein, “workpiece” refers to any article of manufacture comprising a solder bonded to at least one component. For example, workpieces can include surface-mount components (“SMCs”) to circuit boards such as connectors. As used herein, a “component comprising a dynamic cross-linked polymer composition” refers to any article of manufacture comprising a dynamic cross-linked polymer composition.

As used herein, the term “solder” refers to a fusible metal composition, such an alloy, that is used to join one or more components to one another. Solders can be lead-based solders. Preferred lead-based solders comprise tin and lead. Typically, such solders comprise between 30 wt. % and 95 wt. %, or between about 30 wt. % and about 95 wt. %, of lead. Solders used in the disclosure can alternatively be lead-free solders. Lead-free solders can comprise tin, copper, silver, bismuth, indium, zinc, antimony, or a combination thereof. Preferred lead-free solders comprise tin, silver, and copper. Other solders useful in the present disclosure include those comprising tin, zinc, and copper; lead, tin, and antimony; tin, lead, and zinc; tin, lead, and zinc; tin, lead, and copper; tin, lead, and phosphorous; tin, lead, and copper; and lead, tin, and silver. As used herein, lead-free may be defined according to the Restriction of Hazardous Substances in Electrical and Electronic Equipment (RoHS) Directive (2002/95/EC) which provides that lead content is less than 0.1% by weight in accordance with IPC/EIA J-STD-006.

The dynamic cross-linked polymer compositions of the disclosure can be produced by combining an epoxy-containing component; a carboxylic acid component or a polyester component; and a transesterification catalyst. In preferred embodiments, the dynamic cross-linked polymer compositions of the disclosure can be produced by combining an epoxy-containing component; a carboxylic acid component; and a transesterification catalyst. In other embodiments, the dynamic cross-linked polymer compositions of the disclosure can be produced by combining an epoxy-containing component; a polyester component; and a transesterification catalyst. Each of these components, as well as transesterification catalysts, are defined herein. The dynamic cross-linked polymer compositions of the disclosure can further comprise one or more additives. For example, the dynamic cross-linked polymer compositions used in the disclosure can further comprise a pigment, a dye, a filler, a plasticizer, a fiber, a flame retardant, an antioxidant, a lubricant, wood, glass, metal, an ultraviolet agent, an anti-static agent, an anti-microbial agent, or a combination thereof. Examples of such additives are described herein. Exemplary methods for producing dynamic cross-linked polymer compositions are described in U.S. Provisional Application No. 62/026,458, filed Jul. 18, 2014.

Also within the scope of the disclosure are methods comprising applying a solder to a first component comprising a dynamic cross-linked polymer composition; and heating the solder to a temperature that is at or above the melting point of the solder; wherein the dynamic cross-linked polymer composition exhibits a storage modulus of at least 0.01 MPa after the heating. The solder used in these methods can be any type of solder described herein, such as a lead-based solder or a lead-free solder. The temperatures achieved in the methods of the disclosure can be up to 300° C., or up to about 300° C., for example, 150° C. to 265° C., or about 150° C. to about 265° C. Preferred temperatures include about 150, 160, 170, 180, 190, 200, 210, 220, 230, 240, 250, 260, 270, 280, 290, and 300° C.

After heating, the dynamic cross-linked polymer composition of the component exhibits a storage modulus of at least 0.01 MPa after the heating step. In some embodiments, the storage modulus is at least 1 MPa. In some embodiments, the storage modulus is up to 10,000 MPa, or up to about 10,000 MPa. In preferred embodiments, the storage modulus is about 0.01, 0.02, 0.03, 0.04, 0.05, 0.06, 0.07, 0.08, 0.9, 1.0, 1.1, 1.2, 1.3, 1.4, 1.5, 1.6, 1.7, 1.8, 1.9, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 225, 230, 235, 240, 245, 250, 255, 260, 265, 270, 275, 280, 285, 290, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1500, 2000, 2500, 3000, 3500, 4000, 4500, 5000, 5500, 6000, 6500, 7000, 7500, 8000, 8500, 9000, or 10,000 MPa.

In some embodiments, the methods further comprise contacting the melted solder to a second component. As used herein, the “second component” refers to any article of manufacture. The second component can comprise a dynamic cross-linked polymer composition. The dynamic cross-linked polymer composition of the second component can be the same or different than the dynamic cross-linked polymer composition of the first component. The dynamic cross-linked polymer compositions of use in these methods can be produced by combining an epoxy-containing component; a carboxylic acid component or a polyester component; and a transesterification catalyst. In preferred embodiments, the dynamic cross-linked polymer compositions of these methods can be produced by combining an epoxy-containing component; a carboxylic acid component; and a transesterification catalyst. In other embodiments, the dynamic cross-linked polymer compositions of these methods can be produced by combining an epoxy-containing component; a polyester component; and a transesterification catalyst. Each of these components, as well as transesterification catalysts, are defined herein. The dynamic cross-linked polymer compositions of the disclosure can further comprise one or more additives. For example, the dynamic cross-linked polymer compositions used in the disclosure can further comprise a pigment, a dye, a filler, a plasticizer, a fiber, a flame retardant, an antioxidant, a lubricant, wood, glass, metal, an ultraviolet agent, an anti-static agent, an anti-microbial agent, or a combination thereof. Examples of such additives are described herein. Exemplary methods for producing dynamic cross-linked polymer compositions are described in U.S. Provisional Application No. 62/026,458, filed Jul. 18, 2014.

The second component can also comprise materials that do not include dynamic cross-linked polymer compositions. For example, the second component can comprise metal, metal alloys, or metalloids, for example, steel, copper, silicon, aluminum, and the like. The second component can also comprise any material that can withstand soldering temperatures, for example, polycyclohexylenedimethylene terephthalate (PCT), PA4T™ (Royal DSM N.V.), and liquid crystal polymers.

In one example, the disclosure relates to a method comprising: combining in an extruder an epoxy-containing component; a carboxylic acid component or a polyester component; and a transesterification catalyst to form a mixture; and forming a network through heat treatment to form a dynamically cross-linked polymer composition, applying a solder to a first component comprising the dynamic cross-linked polymer composition; and heating the solder to a temperature that is at or above the melting point of the solder. In a further example, the dynamic cross-linked polymer composition can exhibit storage modulus of at least 0.01 MPa after the heating. By means of example and not to be limiting, heat treatment can include, post curing, thermoforming, compression molding, injection molding, or a combination thereof.

Also within the scope of the disclosure are articles of manufacture prepared according to any of the methods described herein. For example, articles that can be produced using the materials and methods of the disclosure include those in the electrical field, for example, computer and lighting articles. Preferred articles include those that are soldered onto a printed circuit board and all surface mount devices. These articles include, but are not limited to, printed circuit boards having connectors, bobbins, ignition coils CPU housings, integrated circuits, transistors, diodes, wiring boxes, and the like. Within the scope of the disclosure, the circuit board (base) and/or the component being soldered to the circuit board, can comprise a dynamic cross-linked polymer composition.

Epoxy-Containing Component

The epoxy-containing component can be a monomer, an oligomer, or a polymer. Generally, the epoxy-containing component has at least two epoxy groups, and can also include other functional groups as desired, for example, hydroxyl (—OH). In preferred embodiments, the epoxy-containing component is a bifunctional bisphenol A oligomer diglycidyl ether, a bifunctional terephthalic diglycidyl ether, a trifunctional terephthalic diglycidyl ether, or a combination thereof. Glycidyl epoxy resins, for example, bifunctional bisphenol A oligomer diglycidyl ethers, are particularly preferred epoxy-containing components.

One exemplary glycidyl epoxy ether is bisphenol A diglycidyl ether (BADGE), which can be considered a monomer, oligomer or a polymer, and is shown below as Formula (A):

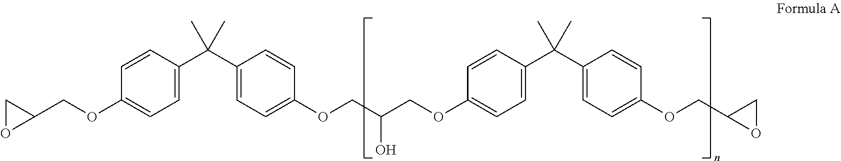

The value of n may be from 0 to 25 in Formula (A). When n=0, this is a monomer. When n=1 to 7, this is an oligomer. When n=8 to 25, this is a polymer. BADGE-based resins have excellent electrical properties, low shrinkage, good adhesion to numerous metals, good moisture resistance, good heat resistance and good resistance to mechanical impacts. BADGE oligomers (where n=1 or 2) are commercially available as D.E.R.™ 671 from Dow, which has an epoxide equivalent of 475-550 grams/equivalent, 7.8-9.4% epoxide, 1820-2110 millimole (mmol) of epoxide/kilogram (kg), a melt viscosity at 150° C. of 400-950 milliPascals-seconds (mPa-sec), and a softening point of 75-85° C.

Novolac resins can be used as the resin precursor as well. The epoxy resins are obtained by reacting phenol with formaldehyde in the presence of an acid catalyst to produce a novolac phenolic resin, followed by a reaction with epichlorohydrin in the presence of sodium hydroxide as catalyst. These epoxy resins are illustrated as Formula (B):

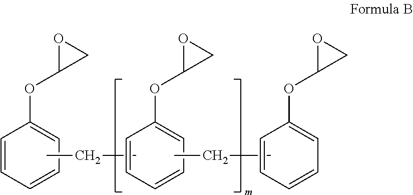

wherein m is a value from 0 to 25.

Another useful epoxide is depicted in Formula C.

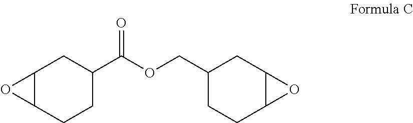 [SMILES: O=C(OCC1CCC2OC2C1)C1CCC2OC2C1]

Other useful epoxides are bifunctional terephthalic diglycidyl ethers. An example of such an epoxide is depicted in Formula D.

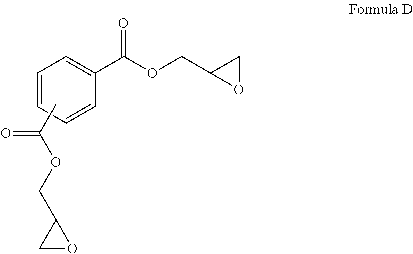

Other useful epoxides are trifunctional terephthalic diglycidyl ethers. An example of such an epoxide is depicted in Formula E.

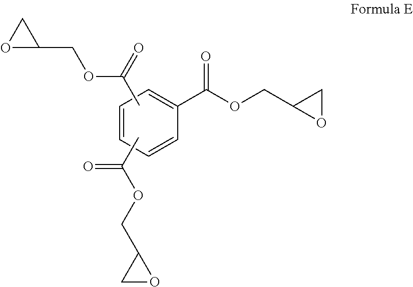

Mixtures of epoxide-containing components are also within the scope of the disclosure. For example, ARALDITE PT910 is a mixture of bifunctional and trifunctional glycidyl esters of terephthalic acid in a ratio of about 80:20, respectively. Within the scope of the disclosure, any ratio of epoxy components can be used.

### Carboxylic Acid Component

Carboxylic acids react with epoxide groups to form esters. The presence of at least two carboxylic acid moieties is necessary to crosslink the dynamic cross-linked polymer compositions described herein. Carboxylic acid components comprising at least three carboxylic acid moieties enables the formation of a three-dimensional network.

The preparation of the compositions described herein may be performed with one or more carboxylic acid components, including at least one of the polyfunctional carboxylic acid type. Advantageously, the carboxylic acid component is chosen from: carboxylic acids in the form of a mixture of fatty acid dimers and trimers comprising from 2 to 40 carbon atoms, or from about 2 to about 40 carbon atoms.

Preferred carboxylic acid components can comprise 2 to 40 carbon atoms, such as linear diacids (glutaric, adipic, pimelic, suberic, azelaic, sebacic or dodecanedioic and homologues thereof of higher masses) and also mixtures thereof, or fatty acid derivatives. It is preferred to use trimers (oligomers of 3 identical or different monomers) and mixtures of fatty acid dimers and trimers, in particular of plant origin. These compounds result from the oligomerization of unsaturated fatty acids such as: undecylenic, myristoleic, palmitoleic, oleic, linoleic, linolenic, ricinoleic, eicosenoic or docosenoic acid, which are usually found in pine oil, rapeseed oil, corn oil, sunflower oil, soybean oil, grapeseed oil, linseed oil and jojoba oil, and also eicosapentaenoic acid and docosahexaenoic acid, which are found in fish oils.

Also preferred are aromatic carboxylic acid components comprising 2 to 40 carbon atoms, like aromatic diacids such as phthalic acid, trimellitic acid, terephthalic acid, naphthalenedicarboxylic acid.

Examples of fatty acid trimers include the compounds of the following formulae that illustrate cyclic trimers derived from fatty acids containing 18 carbon atoms, given that the compounds that are commercially available are mixtures of steric isomers and of positional isomers of these structures, which are optionally partially or totally hydrogenated.

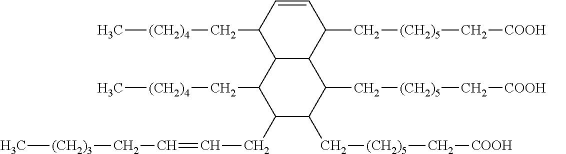

A mixture of fatty acid oligomers containing linear or cyclic C₁₈ fatty acid dimers, trimers and monomers, the said mixture predominantly being dimers and trimers and containing a small percentage (usually less than 5%) of monomers, may thus be used. Preferably, the said mixture comprises:
0.1% to 40% by weight and preferably 0.1% to 5% by weight of identical or different fatty acid monomers,
0.1% to 99% by weight and preferably 18% to 85% by weight of identical or different fatty acid dimers, and
0.1% to 90% by weight and preferably 5% to 85% by weight of identical or different fatty acid trimers.

Examples of fatty acid dimers/trimers include (weight %):
PRIPOL™ 1017 from Uniqema or Croda, mixture of 75-80% dimers and 18-22% trimers with about 1-3% fatty acid monomers,
PRIPOL™ 1048 from Uniqema or Croda, 50/50% mixture of dimers/trimers,
PRIPOL™ 1013 from Uniqema or Croda, mixture of 95-98% dimers and 2-4% trimers with 0.2% maximum of fatty acid monomers,
PRIPOL™ 1006 from Uniqema or Croda, mixture of 92-98% dimers and a maximum of 4% trimers with 0.4% maximum of fatty acid monomers,
PRIPOL™ 1040 from Uniqema or Croda, mixture of fatty acid dimers and trimers with at least 75% trimers and less than 1% fatty acid monomers,
UNIDYME™ 60 from Arizona Chemicals, mixture of 33% dimers and 67% trimers with less than 1% fatty acid monomers,
UNIDYME™ 40 from Arizona Chemicals, mixture of 65% dimers and 35% trimers with less than 1% fatty acid monomers,
UNIDYME™ 14 from Arizona Chemicals, mixture of 94% dimers and less than 5% trimers and other higher oligomers with about 1% fatty acid monomers,
EMPOL™ 1008 from Cognis, mixture of 92% dimers and 3% higher oligomers, essentially trimers, with about 5% fatty acid monomers,
EMPOL™ 1018 from Cognis, mixture of 81% dimers and 14% higher oligomers, essentially trimers, with about 5% fatty acid monomers,
RADIACID™ 0980 from Oleon, mixture of dimers and trimers with at least 70% trimers.

The products PRIPOL™, UNIDYME™, EMPOL™ and RADIACID™ comprise C₁₈ fatty acid monomers and fatty acid oligomers corresponding to multiples of C₁₈.

Other preferred carboxylic acid components include polyoxyalkylenes (polyoxoethylene, polyoxopropylene, etc.) comprising carboxylic acid functions at the ends, phosphoric acid, polyesters and polyamides, with a branched or unbranched structure, comprising carboxylic acid functions at the ends.

Preferably, the carboxylic acid component is chosen from: fatty acid dimers and trimers and polyoxyalkylenes comprising carboxylic acids at the ends.

The carboxylic acid component can also be in the form of an anhydride. Preferred anhydrides include cyclic anhydrides, for instance phthalic anhydride, methylnadic anhydride, hexahydrophthalic anhydride, dodecylsuccinic anhydride or glutaric anhydride. Other preferred anhydrides include succinic anhydride, maleic anhydride, chlorendic anhydride, nadic anhydride, tetrachlorophthalic anhydride, pyromellitic dianhydride, 1,2,3,4-cyclopentanetetracarboxylic acid dianhydride, and aliphatic acid polyanhydrides such as polyazelaic polyanhydride and polysebacic polyanhydride.

By using an equimolar ratio between the hydroxyl/epoxy groups of the epoxy-containing component and the carboxylic acid groups of the carboxylic acid component, a moderately crosslinked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of carboxylic acid groups.

### Polyester Component

Also present in the compositions described herein are polymers that have ester linkages, i.e., polyesters. The polymer can be a polyester, which contains only ester linkages between monomers. The polymer can also be a copolyester, which is a copolymer containing ester linkages and potentially other linkages as well.

The polymer having ester linkages can be a polyalkylene terephthalate, for example, poly(butylene terephthalate), also known as PBT, which has the structure shown below:

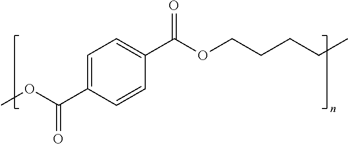

where n is the degree of polymerization, and can be as high as 1,000, or about 1,000, and the polymer may have a weight average molecular weight of up to 100,000, or up to about 100,000.

The polymer having ester linkages can be poly(ethylene terephthalate), also known as PET, which has the structure shown below:

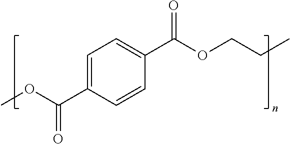

where n is the degree of polymerization, and can be as high as 1,000, and the polymer may have a weight average molecular weight of up to 100,000 Daltons.

The polymer having ester linkages can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a copolyester. The resulting copolyester has the structure shown below:

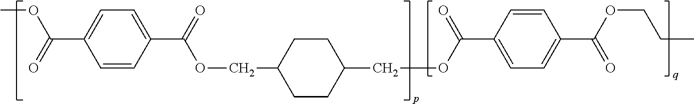

where p is the molar percentage of repeating units derived from CHDM, q is the molar percentage of repeating units derived from ethylene glycol, and p>q, and the polymer may have a weight average molecular weight of up to 100,000, or up to about 100,000 Daltons.

The polymer having ester linkages can also be PETG. PETG has the same structure as PCTG, except that the ethylene glycol is 50 mole % or more of the diol content. PETG is an abbreviation for polyethylene terephthalate, glycol-modified.

The polymer having ester linkages can be poly(1,4-cyclohexane-dimethanol-1,4-cyclohexanedicarboxylate), i.e. PCCD, which is a polyester formed from the reaction of CHDM with dimethyl cyclohexane-1,4-dicarboxylate. PCCD has the structure shown below:

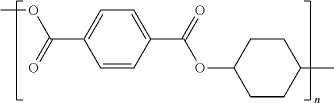

where n is the degree of polymerization, and can be as high as 1,000, and the polymer may have a weight average molecular weight of up to 100,000 Daltons, or up to about 100,000 Daltons.

The polymer having ester linkages can be poly(ethylene naphthalate), also known as PEN, which has the structure shown below:

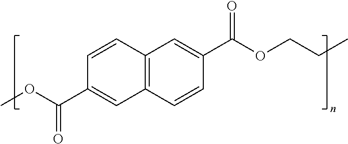

where n is the degree of polymerization, and can be as high as 1,000, and the polymer may have a weight average molecular weight of up to 100,000 Daltons, or up to about 100,000 Daltons.

The polymer having ester linkages can also be a copolyestercarbonate. A copolyestercarbonate contains two sets of repeating units, one having carbonate linkages and the other having ester linkages. This is illustrated in the structure below:

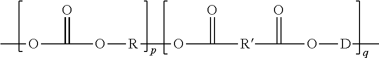

where p is the molar percentage of repeating units having carbonate linkages, q is the molar percentage of repeating units having ester linkages, and p+q=100%; and R, R′, and D are independently divalent radicals.

The divalent radicals R, R′ and D can be made from any combination of aliphatic or aromatic radicals, and can also contain other heteroatoms, such as for example oxygen, sulfur, or halogen. R and D are generally derived from dihydroxy compounds, such as the bisphenols of Formula (A). In particular embodiments, R is derived from bisphenol-A. R′ is generally derived from a dicarboxylic acid. Exemplary dicarboxylic acids include isophthalic acid; terephthalic acid; 1,2-di(p-carboxyphenyl)ethane; 4,4′-dicarboxydiphenyl ether; 4,4′-bisbenzoic acid; 1,4-, 1,5-, or 2,6-naphthalenedicarboxylic acids; and cyclohexane dicarboxylic acid. As additional examples, the repeating unit having ester linkages could be butylene terephthalate, ethylene terephthalate, PCCD, or ethylene naphthalate as depicted above.

Aliphatic polyesters can also be used. Examples of aliphatic polyesters include polyesters having repeating units of the following formula:

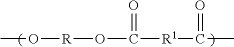

where at least one R or R′ is an alkyl-containing radical. They are prepared from the polycondensation of glycol and aliphatic dicarboxylic acids.

By using an equimolar ratio between the hydroxyl/epoxy groups of the epoxy-containing component and the ester groups of the polymer having ester linkages, a moderately crosslinked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of ester groups.

The mole ratio of hydroxyl/epoxy groups (from the epoxy-containing component) to the ester groups (from the polymer having ester linkages) in the system is generally from 1:100 to 5:100, or from about 1:100 to about 5 to 100.

### Transesterification Catalyst

Certain transesterification catalysts make it possible to catalyze the reactions described herein. The transesterification catalyst is used in an amount up to about 25 mol %, for example, 0.01 mol % to 25 mol %, of the total molar amount of ester groups in the polyester component. In some embodiments, the transesterification catalyst is used in an amount of from 0.01 mol % to 10 mol % or from 1 mol % to less than 5 mol %. In further embodiments, the transesterification catalyst is used in an amount of from about 0.01 mol % to about 10 mol % or from about 1 mol % to less than about 5 mol %. Preferred embodiments include 0.01 or about 0.01, 0.025 or about 0.025, 0.05 or about 0.05, 0.1 or about 0.1, 0.2 or about 0.2 mol % of catalyst, based on the number of ester groups in the polyester component. Alternatively, the catalyst is used in an amount of from 0.1% to 10%, or from about 0.1% to about 10%, by mass relative to the total mass of the reaction mixture, and preferably from 0.5% to 5%.

Transesterification catalysts are known in the art and are usually chosen from metal salts, for example, acetylacetonates, of zinc, tin, magnesium, aluminum, cobalt, calcium, titanium, chromium, and zirconium.

Tin compounds such as dibutyltinlaurate, tin octanote, dibutyltin oxide, dioxtyltin, dibutyldimethoxytin, tetraphenyltin, tetrabutyl-2,3-dichlorodistannoxane, and all other stannoxanes are envisioned as suitable catalysts.

Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used.

Salts of saturated or unsaturated fatty acids and metals, alkali metals, alkaline earth and rare earth metals, for example zinc stearate, are also envisioned as suitable catalysts.

Other catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; and phosphazenes.

The catalyst may also be an organic compound, such as benzyldimethylamide or benzyltrimethylammonium chloride. These catalysts are generally in solid form, and advantageously in the form of a finely divided powder. Preferred catalysts include zinc(II)acetylacetonate, zinc(II)lactate, zinc(II)oxide, aluminum(III)acetylacetonate, or a combination thereof. Zinc(II)acetylacetonate is a particularly preferred catalyst.

Suitable transesterification catalysts are also described in Otera, J. Chem. Rev. 1993, 93, 1449-1470. Tests for determining whether a catalyst will be appropriate for a given polymer system within the present scope are described in, for example, U.S. Published Application No. 2011/0319524 and WO 2014/086974.

### Additives

Other additives may be present in the compositions described herein, as desired. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, and metals, and combinations thereof.

Exemplary polymers that can be mixed with the compositions described herein include elastomers, thermoplastics, thermoplastic elastomers, and impact additives. The compositions described herein may be mixed with other polymers such as a polyester, a polyestercarbonate, a bisphenol-A homopolycarbonate, a polycarbonate copolymer, a tetrabromo-bisphenol A polycarbonate copolymer, a polysiloxane-co-bisphenol-A polycarbonate, a polyesteramide, a polyimide, a polyetherimide, a polyamideimide, a polyether, a polyethersulfone, a polyepoxide, a polylactide, a polylactic acid (PLA), an acrylic polymer, polyacrylonitrile, a polystyrene, a polyolefin, a polysiloxane, a polyurethane, a polyamide, a polyamideimide, a polysulfone, a polyphenylene ether, a polyphenylene sulfide, a polyether ketone, a polyether ether ketone, an acrylonitrile-butadiene-styrene (ABS) resin, an acrylic-styrene-acrylonitrile (ASA) resin, a polyphenylsulfone, a poly(alkenylaromatic) polymer, a polybutadiene, a polyacetal, a polycarbonate, an ethylene-vinyl acetate copolymer, a polyvinyl acetate, a liquid crystal polymer, an ethylene-tetrafluoroethylene copolymer, an aromatic polyester, a polyvinyl fluoride, a polyvinylidene fluoride, a polyvinylidene chloride, tetrafluoroethylene, or any combination thereof.

The additional polymer can be an impact modifier, if desired. Suitable impact modifiers may be high molecular weight elastomeric materials derived from olefins, monovinyl aromatic monomers, acrylic and methacrylic acids and their ester derivatives, as well as conjugated dienes that are fully or partially hydrogenated. The elastomeric materials can be in the form of homopolymers or copolymers, including random, block, radial block, graft, and core-shell copolymers.

A specific type of impact modifier may be an elastomer-modified graft copolymer comprising (i) an elastomeric (i.e., rubbery) polymer substrate having a Tg less than 10° C. or less than about 10° C., less than 0° C. or less than about 0° C., less than −10° C. or less than about −10° C., or between −40° C. to −80° C. or between about −40° C. to −80° C., and (ii) a rigid polymer grafted to the elastomeric polymer substrate. Materials suitable for use as the elastomeric phase include, for example, conjugated diene rubbers, for example polybutadiene and polyisoprene; copolymers of a conjugated diene with less than 50 wt. %, or less than about 50 wt %, of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁-C₈ alkyl(meth)acrylates; elastomeric copolymers of C₁-C₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific impact modifiers include styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

The compositions described herein may comprise a UV stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. Specific UV stabilizers include poly[(6-morphilino-s-triazine-2,4-diyl)[2,2,6,6-tetramethyl-4-piperidyl)imino]-hexamethylene [(2,2,6,6-tetramethyl-4-piperidyl)imino], 2-hydroxy-4-octyloxybenzophenone (Uvinul™3008); 6-tert-butyl-2-(5-chloro-2H-benzotriazole-2-yl)-4-methylphenyl (Uvinul™ 3026); 2,4-di-tert-butyl-6-(5-chloro-2H-benzotriazole-2-yl)-phenol (Uvinul® 3027); 2-(2H-benzotriazole-2-yl)-4,6-di-tert-pentylphenol (Uvinul™ 3028); 2-(2H-benzotriazole-2-yl)-4-(1,1,3,3-tetramethylbutyl)-phenol (Uvinul™ 3029); 1,3-bis[(2′-cyano-3′,3′-diphenylacryloyl)oxy]-2,2-bis-{[(2′-cyano-3′,3′-diphenylacryloyl)oxy}methyl]-propane (Uvinul™ 3030); 2-(2H-benzotriazole-2-yl)-4-methylphenol (Uvinul™ 3033); 2-(2H-benzotriazole-2-yl)-4,6-bis(1-methyl-1-phenyethyl) phenol (Uvinul™ 3034); ethyl-2-cyano-3,3-diphenylacrylate (Uvinul™ 3035); (2-ethylhexyl)-2-cyano-3,3-diphenylacrylate (Uvinul™ 3039); N,N′-bisformyl-N,N′-bis (2,2,6,6-tetramethyl-4-piperidinyl)hexamethylenediamine (Uvinul™ 4050H); bis-(2,2,6,6-tetramethyl-4-pipieridyl)-sebacate (Uvinul™ 4077H); bis-(1,2,2,6,6-pentamethyl-4-piperdiyl)-sebacate+methyl-(1,2,2,6,6-pentamethyl-4-piperidyl)-sebacate (Uvinul™ 4092H); or combinations thereof. Other UV stabilizers include Cyasorb 5411, Cyasorb UV-3638, Uvinul 3030, and/or Tinuvin 234.

The compositions described herein may comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ MH1657 (Atofina), IRGASTAT™ P18 and P22 (Ciba-Geigy). Other polymeric materials may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15% by weight, or about 0.05% to about 15% by weight, relative to the weight of the overall composition.

The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose, and nanocellulose fibers or a combination thereof. Plant fibers (linseed, hemp, sisal, bamboo, etc.) may also be used within the scope of the disclosure. In exemplary aspects, glass fibers are added to the dynamic cross-linked compositions of the disclosure. The glass fibers can, for example, improve stiffness of the dynamic cross-linked polymer compositions. The glass fibers can also improve dimensional stability during reflow simulation experiments of the dynamic cross-linked polymer compositions. In some aspects, the glass fiber can be a reinforcing filler that increases the flexural modulus and/or strength of the dynamic cross linked compositions. The diameter of the glass fibers can range from about 5 μm (micrometer) to about 35 μm, for example 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 μm. In a preferred aspect, the glass fibers have a diameter of about 13 μm. The glass fibers have a length of greater than 0.01 mm, greater than about 0.01 mm. The glass fibers have a length of 0.01 mm to 10 mm, or about 0.01 mm to about 10 mm. In exemplary embodiments, the glass fibers used in the disclosure may be selected from E-glass, S-glass, AR-glass, T-glass, D-glass R-glass, and combinations thereof. As an example, the glass fiber can be an “E” glass type which is a class of fibrous glass filaments comprised of lime-alumino-borosilicate glass. As a further example, the glass fiber may have a length of 5 mm, or about 5 mm.

In further aspects, the compositions disclosed herein may comprise chopped glass fiber. The diameter of the chopped glass can range from about 5 μm (micrometer) to about 35 μm, for example 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 μm. The length of the chopped glass can range from about 10 μm to about 250 μm, for example 20, 30, 40, 50, 60, 70, 80, 90, 100, 110, 120, 130, 140, 150, 160, 170, 280, 190, 200, 210, 220, 230, or 240 μm. In a preferred aspect, the chopped glass may have a diameter of about 14 μm. In some embodiments, the chopped glass may be selected from E-glass, S-glass, AR-glass, T-glass, D-glass R-glass, and combinations thereof. As an example, the chopped glass can be an “E” glass type.

Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming or recycling an article made of the compositions described herein.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO2, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Various types of flame retardants can be utilized as additives. In one embodiment, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. Rimar salt and KSS and NATS, alone or in combination with other flame retardants, are particularly useful in the compositions disclosed herein. In certain embodiments, the flame retardant does not contain bromine or chlorine.

The flame retardant additives may include organic compounds that include phosphorus, bromine, and/or chlorine. In certain embodiments, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

Some suitable polymeric or oligomeric flame retardants include: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; 2,2-bis-(3,5-dichloro-4-hydroxyphenyl)-propane; and 2,2-bis-(3-bromo-4-hydroxyphenyl)-propane. Other flame retardants include: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety. Other flame retardants include tetra-bromo bisphenol A (TBBA) oligomers, poly(pentabromobenzylacrylate), brominated polystryrene, poly(dibromostyrene).

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Another suitable class of flame retardants is metal hydroxides, for example, magnesium hydroxide and boehmite [AlO(OH)]

Exemplary antioxidant additives include organophosphites such as tris(nonyl phenyl)phosphite, tris(2,4-di-t-butylphenyl)phosphite (“IRGAFOS 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Aspects

The present disclosure pertains to and includes at least the following aspects.

Aspect 1. A workpiece comprising: a solder bonded to at least one component comprising a dynamic cross-linked polymer composition.

Aspect 2. A workpiece consisting of: a solder bonded to at least one component comprising a dynamic cross-linked polymer composition.

Aspect 3. A workpiece consisting essentially of: a solder bonded to at least one component comprising a dynamic cross-linked polymer composition.

Aspect 4. The workpiece of any one of the preceding claims, wherein the solder is a lead-free solder.

Aspect 5. The workpiece of any one of the preceding claims, wherein the dynamic cross-linked polymer composition is produced by combining an epoxy-containing component; a carboxylic acid component or a polyester component; and a transesterification catalyst.

Aspect 6. The workpiece of claim 5, wherein the dynamic cross-linked polymer composition is produced by combining an epoxy-containing component, a carboxylic acid component; and a transesterification catalyst.

Aspect 7. The workpiece of claim 5, wherein the dynamic cross-linked polymer composition is produced by combining an epoxy-containing component, a polyester component, and a transesterification catalyst.

Aspect 8. The workpiece of any one of claims 5 to 7, wherein the epoxy-containing component is a bifunctional bisphenol A oligomer diglycidyl ether, a bifunctional terephthalic diglycidyl ether, a trifunctional terephthalic diglycidyl ether, or a combination thereof.

Aspect 9. The workpiece of any one of claim 5, 7, or 8 wherein the polyester component is a polyalkylene terephthalate.

Aspect 10. The workpiece of any one of claims 5 to 9, wherein the transesterification catalyst is present at 0.01 mol % to 25 mol %.

Aspect 11. The workpiece of any one of claims 5 to 10, wherein the transesterification catalyst is zinc(II)acetylacetonate, zinc(II)lactate, zinc(II)oxide, aluminum(III)acetylacetonate, or a combination thereof.

Aspect 12. The workpiece of any one of the preceding claims, wherein the dynamic cross-linked polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

Aspect 13. A method comprising applying a solder to a first component comprising a dynamic cross-linked polymer composition; and heating the solder to a temperature that is at or above the melting point of the solder; wherein the dynamic cross-linked polymer composition exhibits a storage modulus of at least 0.01 MPa after the heating.

Aspect 14. A method consisting of applying a solder to a first component comprising a dynamic cross-linked polymer composition; and heating the solder to a temperature that is at or above the melting point of the solder; wherein the dynamic cross-linked polymer composition exhibits a storage modulus of at least 0.01 MPa after the heating.

Aspect 15. A method consisting essentially of applying a solder to a first component comprising a dynamic cross-linked polymer composition; and heating the solder to a temperature that is at or above the melting point of the solder; wherein the dynamic cross-linked polymer composition exhibits a storage modulus of at least 0.01 MPa after the heating.

Aspect 16. The method of any of claims 13-15, wherein the temperature is up to 300° C.

Aspect 17. The method of any of claims 13-15, wherein the temperature is up to about 300° C.

Aspect 18. The method of claim 13 or claim 14, or claim 15 or claim 16, wherein the storage modulus is at least 1 MPa.

Aspect 19. The method of claim 13 or claim 14, or claim 15 or claim 16, wherein the storage modulus is at least about 1 MPa.

Aspect 20. The method of any one of claims 13 to 19, further comprising contacting the melted solder to a second component.

Aspect 21. The method of claim 20, wherein the second component comprises a dynamic cross-linked polymer composition.

Aspect 22. The method of any one of claims 13-21, wherein the solder is a lead-free solder.

Aspect 23. An article prepared according to the method of any one of claims 13-22.

Aspect 24. The article of claim 23 that is a printed circuit board having a connector, a bobbin, an ignition coil, a CPU housing, an integrated circuit, a transistor, a diode, a wiring box, or a combination thereof.

Aspect 25. A method comprising: combining in an extruder an epoxy-containing component; a carboxylic acid component or a polyester component; and a transesterification catalyst to form a mixture; and forming a network through heat treatment to form a dynamically cross-linked polymer composition, applying a solder to a first component comprising the dynamic cross-linked polymer composition; and heating the solder to a temperature that is at or above the melting point of the solder; and wherein the dynamic cross-linked polymer composition exhibits a storage modulus of at least 0.01 MPa after the heating.

### EXAMPLES

The following examples are provided to illustrate compositions, processes, and properties described herein. The examples are merely illustrative and are not intended to limit the disclosure to the materials, conditions, or process parameters set forth therein.

### Examples

### Materials

PBT135, molecular weight˜110,000 (SABIC)

D.E.R. 671 (Dow Benelux B.V.)

zinc(II)acetylacetonate (H₂O) (Acros)

IRGANOX 1010 (BASF)

Glass fiber—13 μm diameter (Nippon Electric Glass Co., Ltd)

### Example 1

Three compression molded sheet samples (each ca. 2 mm thickness) with varying levels of cross-linking were prepared by compressing pre-compound pellets in a compression mold at 260° C. for 15 minutes. Pellets were prepared by mixing the PBT315, D.E.R. 671 epoxy, zinc(II)acetylacetonate catalyst and IRGANOX antioxidant and compounding the mixture in a Werner & Pfleiderer Extruder ZSK 25 mm co-rotating twin screw extruder with the settings as described in Table 1. Rpm refers to revolutions per minute. Kg/hr refers to kilograms per hour.

TABLE 1

| Extruder | Units | 25 mm ZSK Extruder |
|---|---|---|
| Die | | 2 hole |
| Feed Temp | ° C. | 40 |
| Zone 1 Temp | ° C. | 70 |
| Zone 2 Temp | ° C. | 190 |
| Zone 3 Temp | ° C. | 240 |
| Zone 4 Temp | ° C. | 270 |
| Zone 5 Temp | ° C. | 270 |
| Zone 6 Temp | ° C. | 270 |
| Zone 7 Temp | ° C. | 270 |
| Zone 8 Temp | ° C. | 270 |
| Die Temp | ° C. | 270 |
| Screw speed | rpm | 300 |
| Throughput | kg/hr | 15-20 |
| Vacuum 1 | bar | −0.8 (full vacuum) |

The samples were evaluated for reflow soldering performance. The formulations and details of these samples are shown in Table 2. All formulations are presented in wt %. Molecular weight (MW) of PBT was determined by gel permeation chromatography (GPC) versus polystyrene (PS) standards. N/d (“n/d”) designates that the value was not determined or observed.

TABLE 2

| | CE1 | Ex2 | Ex3 |
|---|---|---|---|
| PBT315 resin | 99.90 | 96.60 | 93.72 |
| D.E.R. ™ 671 | | 3.07 | 5.96 |
| epoxy | | | |
| Zn(acac)₂•H₂O | | 0.23 | 0.22 |
| Antioxidant 1010 | 0.10 | 0.10 | 0.10 |
| | Sample specifications | | |
| Mol % epoxy + OH | 0 | 2 | 4 |
| Mol % Zn²⁺ | 0 | 0.2 | 0.2 |
| MW of PBT | 110,000 | 110,000 | 110,000 |
| Wt % Moisture | 0.2 | 0.2 | 0.2 |
| | Results reflow simulation | | |
| Dried (control) | n/d | PASS | PASS |
| MSL 2a (60° C./ | Molten | Blistered | PASS |
| 60% RH) | | | |
| MSL 1 (85° C./ | n/d | Blistered | Blistered |
| 85% RH) | | | |

Moisture sensitivity of these samples towards reflow soldering conditions was measured according to the IPC/JEDEC-J-STD-020E (2015) standard (Institute for Printed Circuits/Joint Electron Device Engineering Council). According to this standard, the samples were conditioned prior to reflow solder tests to comply with moisture sensitivity level (MSL) 1 (conditioning for 168 hours at 85° C. and 85% relative humidity (“RH”)) and with MSL 2a (120 hours at 60° C. and 60% RH).

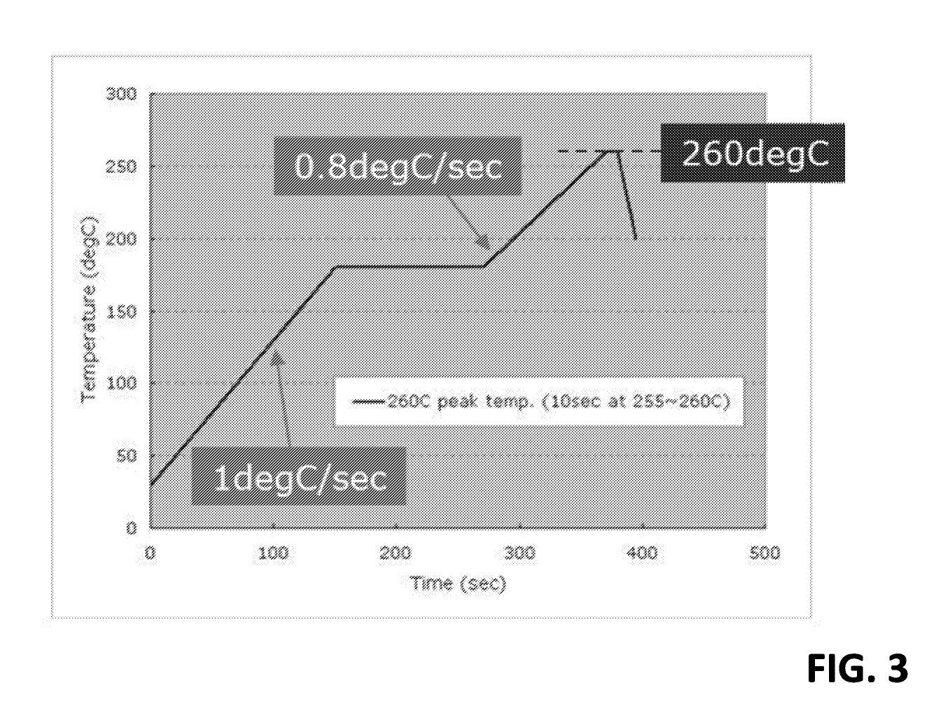

After conditioning, the samples were subjected to a reflow soldering profile using a Malcom SRS-1C reflow simulator, see FIG. 3 for the imposed temperature profile during reflow simulations. A dry sample (dried at 120° C. prior to testing) was also subjected to the same reflow simulation for comparison. Table 2 summarizes the results of the reflow simulation reported as either “PASS” or with one of the most modes of not meeting reflow simulation specification including: blistering, deformation or melting of the sample. Performance increased with an increase in cross-linker content (see samples Ex4 and Ex5). When no cross-linker is added to the polymer composition, as in CE3, the sample did not meet the reflow simulation specification because of melting at the high temperatures during the reflow simulation. These temperatures were above the melting temperature of PBT, about 220° C.).

### Example 2

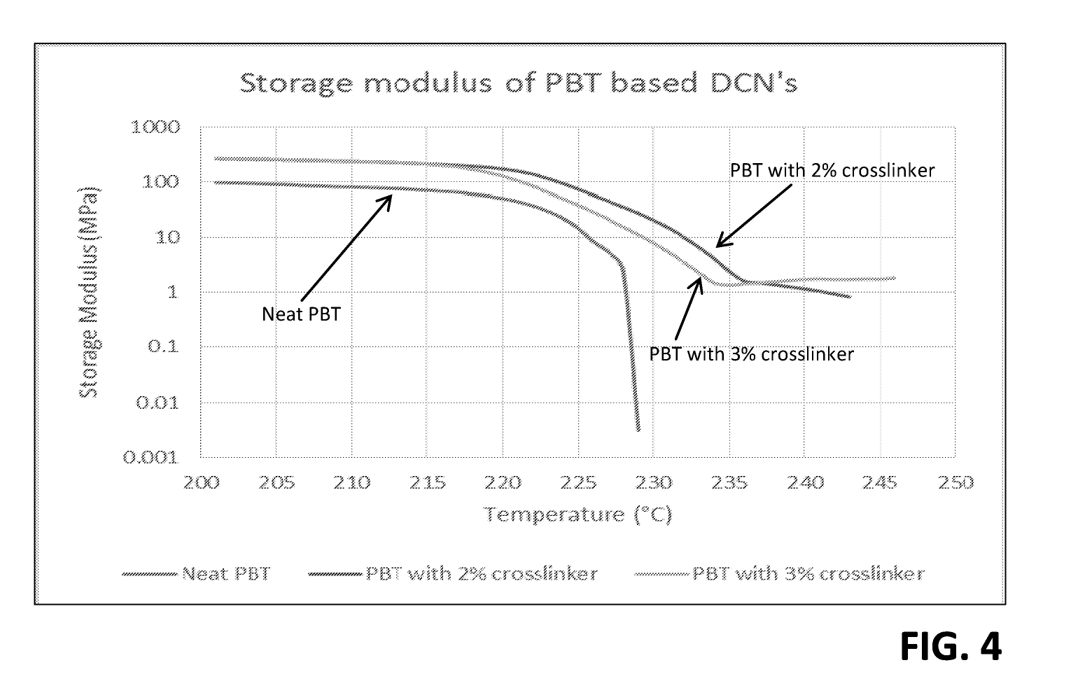

Mechanical properties of the dynamic cross-linked polymer compositions were evaluated. The storage (elastic) modulus of the formulations prepared according to Table 2 were measured using dynamic mechanical thermal analysis (DMTA) methods based on ISO 6721-1, 6721-4, 6721-5, 6721-6 standards using a TA Instruments Q800 dynamic mechanical analysis instrument. DMTA was conducted in bending mode using a temperature sweep from 200° C. to 250° C. at a heating rate of 3° C./min and a frequency of 1 Hz at 0.02% strain, see FIG. 4.

### Example 3

The effect of processing conditions on reflow simulation results were evaluated by observing compression molding (i.e., Example 1) versus injection molding and the effect of post-curing. Injection molding was performed at 250° C. with residence times of 2-3 minutes, optionally followed by a heat treatment step in an oven to post-cure the sample. Formulation Ex3 from Table 2 was also used to prepare an injection-molded test sample of 3 millimeter (mm) thickness (sample CE4). The sample was prepared using injection molding at about 270° C. with longer residence times (˜6 minutes) so that curing and network formation occurred in the injection molding machine, for an in-situ curing. No post-curing step was applied for the sample CE4. Results are shown in Table 3. All formulations are presented as a weight percent. As can be seen in Table 3, when no post-curing is done, the injection-molded sample did not meet the reflow simulation specification even at dry conditions because of very severe deformation, regardless of the conditioning profile used. The observed deformation is attributed high residual stresses from injection molding of the dynamic cross-link polymer parts. Under longer residence times in the injection molding machine, the dynamic network is already formed prior to molding During the molding step, cross-linked material is packed together and frozen in rapidly in the mold leading to a poorly packed molded part with high internal stresses that are released upon heating in the reflow simulation.

Sample Ex5 was injection-molded at shorter residence times (generally below 2-3 min), followed by a post-curing step of the molded part heated in an oven at about 200° C. for four hours. In contrast to CE4, Ex5 passed the reflow soldering simulations under dry conditions. Thus, preferable reflow soldering samples were prepared using either compression molding or standard injection molding at 250° C. and a residence time of 2-3 minutes, followed by a post-curing step to complete network formation and relax all the internal stresses.

TABLE 3

| | Ex3 | CE4 | Ex5 |
|---|---|---|---|
| PBT315 resin | 93.72 | 93.72 | 94.65 |
| D.E.R. ™ 671 | 5.96 | 5.96 | 5.00 |
| epoxy | | | |
| Zn(acac)₂•H₂O | 0.22 | 0.22 | 0.25 |
| Antioxidant 1010 | 0.10 | 0.10 | 0.10 |
| | Sample preparation | | |
| | Compression | Injection | Injection |
| | molding | molding, no | molding, |
| | | post-curing | followed by |
| | | (i.e., curing | post-curing |
| | | in-situ) | (200° C./4 |
| | | | hours) |
| | Results reflow simulation | | |
| Dried (control) | PASS | Deformed | PASS |
| MSL 2a (60° C./ | PASS | Deformed | n/d |
| 60% RH) | | | |
| MSL 1 (85° C./ | Blistered | Deformed | Blistered |
| 85% RH) | | | |

### Example 4

Dimensional stability of filled dynamic cross-linked polymer compositions was observed. To improve stiffness of the dynamic cross-linked polymer compositions, and to improve dimensional stability during reflow simulation experiments, glass fiber at 13 μm width were added to the dynamic cross-linked polymer compositions, as shown in Table 4. Samples CE6, Ex7, Ex8 and CE9 were 3 mm thick tests samples prepared using injection molding at shorter residence times (about 2 min at about 250° C.) followed by a post-curing step of about 4 hours at 200° C. in an oven to complete dynamic network formation and allow relaxation of internal stresses. The results in Table 4 show that all samples containing glass fiber (Ex7, Ex8 and CE9) did not meet the requirements of the reflow solder tests under MSL 1 conditions. Blistering was observed upon heating samples Ex9, Ex10, and CE11 using the standard reflow simulation protocol. Blistering was attributed to moisture release absorbed during conditioning of the samples. Samples CE6 and Ex7 passed the reflow simulation when dried at 120° C. prior to testing; sample Ex9 also passes after conditioning at MSL 2a requirements. In contrast, CE9 (which was cross-linked, only glass-filled) did not pass the reflow simulation test because the sample melted in the absence of cross-linking.

TABLE 4

| | CE6 | Ex7 | Ex8 | CE9 |
|---|---|---|---|---|
| PBT315 resin | 94.65 | 79.65 | 64.65 | 69.90 |
| D.E.R. ™ 671 epoxy | 5.00 | 5.00 | 5.00 | |
| Zn(acac)₂•H₂O | 0.25 | 0.25 | 0.25 | |
| Glass fiber | | 15.00 | 30.00 | 30.00 |
| Antioxidant 1010 | 0.10 | 0.10 | 0.10 | 0.10 |
| | Results reflow simulation | | | |
| Dried (control) | PASS | PASS | n/d⁽ | n/d |
| MSL 2a (60° C./60% | n/d | PASS | n/d | n/d |
| RH) | | | | |
| MSL 1 (85° C./85% | Blistered | Blistered | Blistered | Molten + |
| RH) | | | | blistered |
| | Moisture uptake during conditioning (wt %) | | | |
| MSL 2a (60° C./60% | n/d | 0.26 | n/d | n/d |
| RH) | | | | |
| MSL 1 (85° C./85% | n/d | 0.51 | n/d | n/d |
| RH) | | | | |

### Example 5

Example 5 shows the importance of eliminating blistering of the sample during reflow simulation by reducing the uptake of moisture during conditioning. In a next series of samples, the amount of cross-linker in the dynamic cross-linked polymer compositions was doubled (Ex11 and CE12 versus CE10). The formulations of these samples, as well as the results of reflow simulations and moisture uptake studies are shown in Table 5 to compare samples having increased amounts of the cross-linking agent (D.E.R.™ 671)

Formulations CE10, Ex11 and CE12 were prepared by injection molding of pre-compound pellets into a mold having the required connector shape for JEDEC reflow simulations. The samples having lower amount of the epoxy cross-linker (CE10) and the unfilled formulation having greater amount epoxy cross-linker (CE12) did not meet the specifications of the reflow simulation under all conditions tested. That the samples did not meet the specifications of the reflow simulation was attributed due to unacceptable deformation of the connector. Sample Ex11 passed the reflow soldering simulation even at the most stringent MSL 1 classification.

Shrinkage of the connector parts was also evaluated after injection molding, post-curing and after reflow soldering simulations at MSL 1 conditions. The percentage shrinkage in length and width direction of the connector part was calculated from the part dimensions after each process step and is shown in Table 5. From the results, it was apparent that the greatest contribution to shrinkage was the width direction of the connector during the reflow simulation as greater than 25% and greater than 11% shrinkage was observed after MSL 1 testing for samples CE10 and Ex11, respectively. Thus, increasing the amount of epoxy cross-linker in the formulation appeared to reduce deformation. However, in the length direction, shrinkage appeared to be larger for the samples with higher cross-linker loadings (compare, about 3% for Ex11 with less than 0.5% for CE10, respectively). The connector part shrinkage (length/with) is presented as a percentage of shrinkage with respect to the previous processing step. It is apparent that the greatest contributor to shrinkage is the width direction of the connector during the reflow simulation. The percentage shrinkage, as reported for the different connector samples was calculated based on the measured dimensions (length×width) of the connector parts after each process step (injection molding, post-curing, conditioning, reflow soldering simulation). When each step is indication by index number i, the percentage of shrinkage in the subsequent process step, i+1 is calculated as:

$$shrinkage ( \% ) = \frac{{d}_{i + 1} - {d}_{i}}{{d}_{i}} \times 100 \%$$

Where, dᵢ and dᵢ₊₁ are the dimensions of the connector part (in either length or width direction) in process steps i and i+1, respectively. For post-molding shrinkage, the dimensions of the connector mold are used as values for dᵢ (length×width=45×5.6 mm).

TABLE 5

| | CE10 | Ex11 | CE12 |
|---|---|---|---|
| PBT315 resin | 79.65 | 74.65 | 89.65 |
| D.E.R. ™ 671 | 5.00 | 10.00 | 10.00 |
| epoxy | | | |
| Zn(acac)₂•H₂O | 0.25 | 0.25 | 0.25 |
| Glass fiber (13 μm) | 15.00 | 15.00 | |
| Antioxidant 1010 | 0.10 | 0.10 | 0.10 |
| | Results reflow simulation | | |
| Dried (control) | Deformed | PASS | Deformed |
| MSL 2a (60° C./ | n/d | n/d | n/d |
| 60% RH) | | | |
| MSL 1 (85° C./ | Deformed | PASS | Deformed |
| 85% RH) | | | |
| | Moisture uptake during conditioning (wt %) | | |
| 23° C./50% RH | 0.13 | 0.11 | 0.12 |
| 90° C./95% RH | 0.60 | 0.56 | 0.55 |
| | Connector part dimensions (length × width, in mm) | | |
| After molding | 44.75 × 4.59 | 44.61 × 4.71 | n/d |
| After post-curing | 44.53 × 4.58 | 43.95 × 4.68 | n/d |
| After reflow | 44.36 × 3.42 | 42.65 × 4.15 | n/d |
| simulation | | | |
| | Connector part shrinkage (length/width, in %) | | |
| After molding | −0.56/−18.0 | −0.87/−15.9 | n/d |
| After post-curing | −0.49/−0.22 | −1.5/−0.64 | n/d |
| After reflow | −0.38/−25.3 | −3.0/−11.3 | n/d |
| simulation | | | |

The amount of moisture uptake during conditioning of the samples cf. MSL 1, 2 and/or 2a requirements, reported as the wt % of moisture in the sample in Table 4, is determined by weighing the sample before and after the conditioning step. Furthermore, when it is assumed that all weight increase is due to the uptake of moisture, the moisture uptake is calculated as:

$$moisture uptake ( wt \% ) = \frac{{m}_{after} - {m}_{before}}{{m}_{before}} \times 100 \%$$

Where, m_{after} and m_{before} are the weights of the sample before and after conditioning, respectively.

Alternatively, moisture content is determined from pre-compound pellets that were post-cured for 4 hours at 200° C. and conditioned for 168 hours at 23° C./50% RH or 90° C./95% RH as shown in Table 5. For measuring the moisture content of these sample series, a Brabender Aquatrac™-3E mobile moisture meter was used. In this device, the polymer test sample is heated to evaporate the moisture which is subsequently analyzed by determining the weight increase of CaH₂ reagent (in a sealed reaction vessel) after the reaction with the moisture from the test sample to form Ca(OH)₂.

### Example 6

Connector samples were evaluated according to JEDEC standards. The formulations as presented in Examples 5 (see: Table 5) and additional formulations in Table 7, below were molded in the shape of connectors and evaluated for their MSL according to JEDEC standards, as provided in Example 1 (IPC/JEDEC-J-STD-020E). The molding conditions are summarized in Table 6. Reflow simulation on these connector samples showed that connectors from Ex11 passes the MSL 1 requirements with no observed blistering and only slight side-wall deformation with the naked eye after storage and heat treatment.

TABLE 6

| | Injection molding conditions | |
|---|---|---|
| | for connector samples | |
| Pre-drying conditions | 4 hours at 120° C. | |
| Cylinder temperature | 245-250° | C. |
| Mold tool | 60° | C. |
| temperature | | |
| Injection speed | 20 | mm/s |
| Holding pressure | 80 | MPa |
| Cooling time | 15 | seconds |

Additional formulations were prepared to explore the design space for further reduction of connector deformation after molding, post-curing and reflow simulation. For these formulations, the amount of D.E.R.™ 671 epoxy cross-linker and glass fiber loading were varied between 5-20 wt % and 5-30 wt %, respectively as shown in Table 7 for formulations CE13, Ex14 and CE15-16. Tensile properties, heat deflection temperatures and shrinkage were also measured.

All samples passed reflow soldering simulation after storage under dried conditions, but only formulation Ex14, having the highest amounts of D.E.R.™ 671 and glass fibers passed the most stringent MSL 1 classification. The effect of increasing glass fiber was also evident. As the glass fiber content increased from 5% to 30%, the shrinkage of the connector in the length direction reduces from greater than 2% to about 0.5%. Sample Ex14 was the only sample that exhibited considerable expansion in width direction (about 15%) due to outward bending of the connector walls after reflow simulation.

TABLE 7

| | CE13 | Ex14 | CE15 | CE16 |
|---|---|---|---|---|
| PBT315 resin | 84.65 | 59.65 | 74.65 | 49.65 |
| D.E.R. ™ 671 | 10.00 | 10.00 | 20.00 | 20.00 |
| epoxy | | | | |
| Zn(acac)₂•H₂O | 0.25 | 0.25 | 0.25 | 0.25 |
| Glass fiber (13 μm) | 5.00 | 30.00 | 5.00 | 30.00 |
| Antioxidant 1010 | 0.10 | 0.10 | 0.10 | 0.10 |
| | Results reflow simulation | | | |
| Dried (control) | PASS | PASS | PASS | PASS |
| MSL 2a (60° C./ | n/d | PASS | n/d | n/d |
| 60% RH) | | | | |
| MSL 1 (85° C./ | Deformed | PASS | Blistered | Blistered |
| 85% RH) | | | | |
| | Moisture uptake during conditioning (wt %) | | | |
| 60° C./60% RH | 0.25 | 0.21 | n/d | n/d |
| 90° C./95% RH | 0.60 | 0.40 | n/d | n/d |
| | Connector part dimensions (length × width, in mm) | | | |
| After molding | 44.31 × 4.65 | 44.81 × 4.86 | n/d | n/d |
| After post-curing | 43.06 × 4.72 | 44.58 × 4.75 | n/d | n/d |
| After reflow | 39.40 × 4.82 | 44.34 × 5.49 | n/d | n/d |
| simulation | | | | |
| | Connector part shrinkage (length/width, in %) | | | |
| After molding | −1.5/−17.0 | −0.42/−13.2 | n/d | n/d |
| After post-curing | −2.8/+1.5 | −0.51/−2.3 | n/d | n/d |
| After reflow | −8.5/+2.1 | −0.54/+15.6 | n/d | n/d |
| simulation | | | | |

1. A workpiece comprising:
a solder bonded to at least one component comprising a dynamic cross-linked polymer composition.

2. The workpiece of claim 1, wherein the solder is a lead-free solder.

3. The workpiece of claim 1, wherein the dynamic cross-linked polymer composition is produced by combining
an epoxy-containing component;
a carboxylic acid component or a polyester component; and
a transesterification catalyst.

4. The workpiece of claim 3, wherein the dynamic cross-linked polymer composition is produced by combining
an epoxy-containing component, a carboxylic acid component; and
a transesterification catalyst.

5. The workpiece of claim 3, wherein the dynamic cross-linked polymer composition is produced by combining
an epoxy-containing component, a polyester component, and a transesterification catalyst.

6. The workpiece of claim 3, wherein the epoxy-containing component is a bifunctional bisphenol A oligomer diglycidyl ether, a bifunctional terephthalic diglycidyl ether, a trifunctional terephthalic diglycidyl ether, or a combination thereof.

7. The workpiece of claim 3, wherein the polyester component is a polyalkylene terephthalate.

8. The workpiece of claim 3, wherein the transesterification catalyst is present at 0.01 mol % to 25 mol %.

9. The workpiece of claim 3, wherein the transesterification catalyst is zinc(II)acetylacetonate, zinc(II)lactate, zinc(II)oxide, aluminum(III)acetylacetonate, or a combination thereof.

10. The workpiece of claim 3, wherein the dynamic cross-linked polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

11. A method comprising:
applying a solder to a first component comprising a dynamic cross-linked polymer composition; and
heating the solder to a temperature that is at or above the melting point of the solder;
wherein the dynamic cross-linked polymer composition exhibits a storage modulus of at least 0.01 MPa after the heating.

12. The method of claim 11, wherein the temperature is up to 300° C.

13. The method of claim 11, wherein the storage modulus is at least 1 MPa.

14. The method of claim 11, further comprising contacting the melted solder to a second component.

15. The method of claim 14, wherein the second component comprises a dynamic cross-linked polymer composition.

16. The method of claim 11, wherein the solder is a lead-free solder.

17. An article prepared according to the method of claim 11.

18. The article of claim 17 that is a printed circuit board having a connector, a bobbin, an ignition coil, a CPU housing, an integrated circuit, a transistor, a diode, a wiring box, or a combination thereof.

19. A method comprising:
combining in an extruder
an epoxy-containing component;
a carboxylic acid component or a polyester component; and
a transesterification catalyst to form a mixture; and
forming a network through heat treatment to form a dynamically cross-linked polymer composition,
applying a solder to a first component wherein the solder comprises the dynamic cross-linked polymer composition; and
heating the solder to a temperature that is at or above the melting point of the solder.
